(19) United States
(12) Patent Application Publication
(10) Pub. No.: US 2013/0042630 A1
(43) Pub. Date: Feb. 21, 2013

(54) GAS TURBINE ENGINE ACCESSORY MOUNT

(71) Applicant: Marc J. Muldoon, Marlborough, CT (US)

(72) Inventor: Marc J. Muldoon, Marlborough, CT (US)

(73) Assignee: UNITED TECHNOLOGIES CORPORATION, Hartford, CT (US)

(21) Appl. No.: 13/213,869

(22) Filed: Aug. 19, 2011

(51) Int. Cl. F02C 7/20

(52) U.S. Cl. 60/796

(57) ABSTRACT

A gas turbine engine accessory mount comprises a bracket fixedly attached to the engine's case, a link adapted for connection to the accessory and bracket and a fastener such as a pin disposed with a frangible fuse bushing, the pin and fuse bushing being received within aligned apertures in the link and bracket such that deflections and distortions of the engine case due to abnormal operating conditions of the engine such as a rotor imbalance due to separation of a blade therefrom, result in a shearing of the fuse busing thereby dissipating energy associated with the case deflections and distortions and isolating the fastener, link and accessory from the case deflections and distortions.

### BACKGROUND OF THE INVENTION

1. Technical Field

The present invention relates to gas turbine engines, and more particularly to a mounting arrangement for a gearbox or other engine accessory to the engine to minimize damage to the accessory in the event of a high rotor imbalance condition such as in the case of a fan blade loss.

2. Background Information

Modern gas turbine aircraft engines have gearboxes and other accessories that are mounted on their external cases. The gearbox uses power from the engine to drive the major accessories needed for engine functions such as generators for electricity and pumps for circulating fluids such as lubricating oil. The accessories are frequently mounted on the gearbox.

The main gearbox of modern turbofan engines such as those used in powering aircraft, is often mounted within the engine core cowl and is driven by a towershaft from the engine's high-pressure compressor. The accessory drives for various components, such as the hydraulic pump, are mounted on the gearbox. The main gearbox drives the fuel pump, scavenge pump, the electrical generator for the electronic engine control, external deoiler, hydraulic pump, and the integrated drive generator (for aircraft electricity).

Various prior art mounting arrangements have been used to mount the gearbox to the external case. The gearbox has often been connected to the engine case at two or more locations along the length of the gearbox. For example, a forward link has been used to fasten the front of the gearbox to the engine. A plurality of side hanger links have been used on either side of the gearbox housing to stabilize the gearbox. Further, a mounting plate has also been used to fasten the gearbox housing to the engine case to provide alignment of the gearbox with respect to the engine case and prevent undesirable movement of the gearbox relative to the engine. Such hard mounts, that is, a connection which are essentially inflexible and immobile cause engine case deflections to be transmitted to the gearbox and impose undesirable loads on the mounting hardware and on the gearbox itself.

One problem caused by mounting the gearbox to the engine case is subjecting the gearbox and engine cases to high loads caused by rotor imbalances. Severe rotor imbalance can occur in an engine, particularly after a fan blade breaks off from the engine's rotor due to impact with foreign objects, such as birds, hailstones or other objects which may be ingested into the engine. Such blade loss produces an imbalance in the rotor and causes the rotor shaft to deflect. The more the rotor deflects, the greater is the radial load on the rotor bearing supports.

The rotor imbalance loads are transmitted from the bearing supports to the engine case and ultimately to the gearbox fastened to the engine case. If the vibratory loads are high, the gearbox or cases may not be able to sustain the imbalance loads resulting in the failure of the gearbox housing or case and often the liberation of accessories mounted on the gearbox.

When the gearbox housing breaks, oil from within the gearbox may splash over the hot engine and ignite, causing a fire. If a fuel-bearing accessory breaks off from the gearbox or pulls apart, spilled fuel may also cause a fire. If the generator pulls off, it may potentially break through the engine cowling itself and ultimately damage an aircraft control surface.

Consequently, gearbox housings have been made thicker and the mount points thereon stronger. However, these prior art solutions have resulted in substantially heavier hardware which in turn has resulted in increased gearbox mount loads. In turn, the efficiency of the engine is adversely impacted by such heavier hardware.

It is also known to employ redundant fasteners such as pins in accessory mounts. In such prior art arrangements, a first break-away mount pin shears off under high load conditions such as the aforementioned fan blade loss situations. A second retention pin in the mount maintains the integrity of the mount and the retention of the gearbox on the engine case in a loose arrangement thereby reducing load transfer from the case to the gearbox. However, the use of such redundant pin arrangements necessarily increases the size of the gearbox mount to the extent that the mount may not fit within available packaging space.

Thus, the challenge for modern gas turbine engines, during high rotor imbalance events, is the limiting of damage to the gearbox mounts and the gearbox itself with a compact energy absorbing mount.

SUMMARY OF THE DISCLOSURE

A primary object of the present invention is to provide an accessory mounting arrangement that protects a gas turbine engine accessory such as a gearbox from the undesirable effects of case deflections and distortions experienced during high rotor imbalance events such as in a fan blade loss event.

In accordance with the present invention, a mount for gas turbine engine accessories such as gearboxes, oil tanks and the like comprises a bracket adapted for fixed attachment to the exterior surface of the engine's case and a link adapted for connection to the accessory component and the mounting bracket wherein the link is connected to the mounting bracket by a fastener received within the link and mounting bracket, the fastener being disposed within a frangible fuse bushing such that deflections and distortions of the engine case due to abnormal operation of the engine such as during a high rotor imbalance condition due to, for example, the liberation of a fan blade from the engine's rotor, results in shearing of the fuse bushing to dissipate the energy associated with the case deflections and distortions and isolate the fastener link and an accessory maintains the connection of the link and bracket with the accessory and engine case from the case deflections and distortions to minimize the risk of damage thereto under such abnormal engine operating conditions. The frangible bushing eliminates the need for separate shear and retention fasteners to isolate the accessory from case distortions and deflections while maintaining the attachment of the accessory to the engine case, thereby representing a compact, effective energy absorbing mount for the accessory which is uncomplicated, cost-effective and compact enough to fit in minimal space allocated for such mounts in modern gas turbine engines.

The foregoing and other objects, features and advantages of the present invention will become more apparent in the following detailed description of the best mode for carrying out the invention and from the accompanying drawings which illustrate an embodiment thereof.

### BRIEF DESCRIPTION OF THE DRAWINGS

FIG. 1 is a perspective view of a typical axial flow turbofan gas turbine engine showing a gearbox mounted to the engine's external case.

FIG. 2 is a perspective view of the gas turbine engine of FIG. 1 with an enlarged view of the gearbox.

FIG. 3 is a sectional elevation of a gas turbine engine accessory mount of the present invention.

FIG. 4 is a side elevation of a gas turbine engine accessory mount of the present invention.

### DETAILED DESCRIPTION OF THE INVENTION

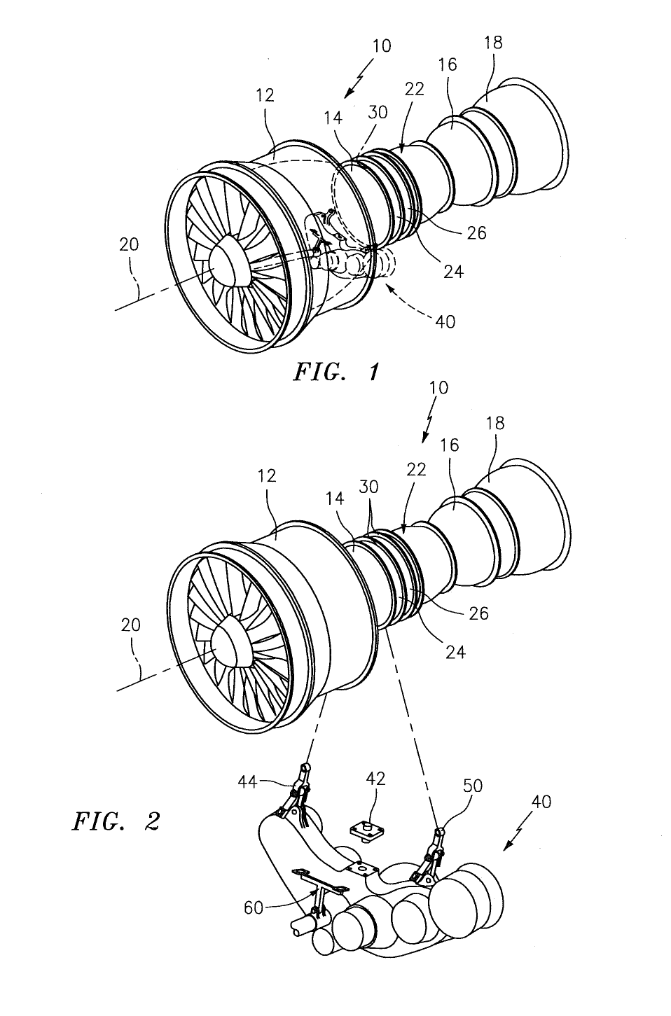

Referring to FIG. 1, a gas turbine engine 10 includes as its principal components, a fan section 12, a compression section 14, a combustion section 16 and a turbine section 18. The compression and turbine sections each contain one or more compressor and turbine stages (not shown) which rotate about a central rotational axis 20. The principal components are circumscribed by an essentially cylindrical external case 22 which serves as a main structural support for the engine. The external case is typically constructed of individual annular case elements, such as elements 24 and 26, which are joined together at a bolted flange connection such as at flange 30. A gearbox 40 is mounted to the external case 22.

Referring to FIG. 2, the gearbox 40 is mounted to the external case by a rigid mount 42 and a plurality of energy absorbing mounts 50 in accordance with the present invention.

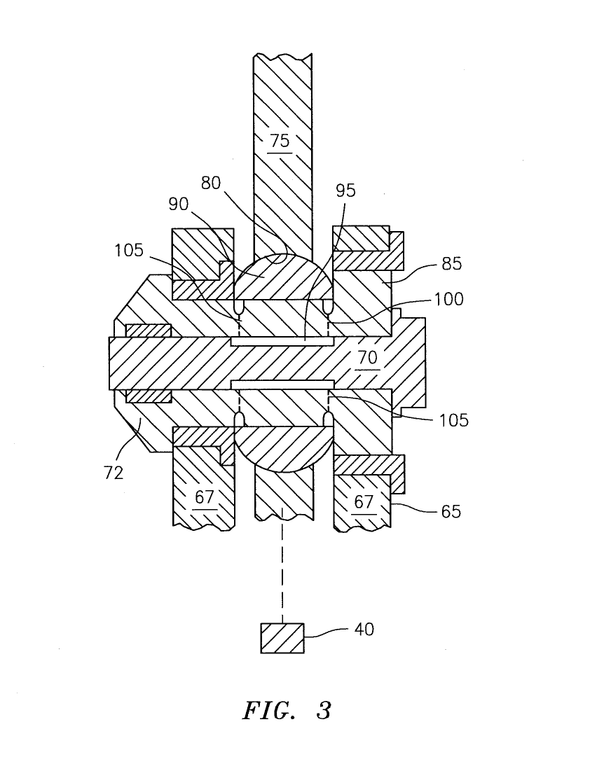

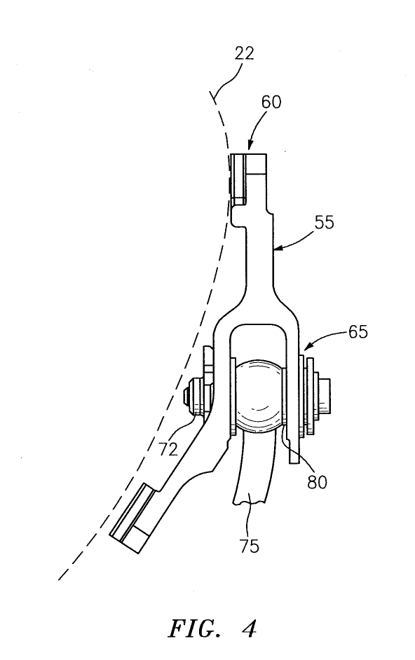

Referring to FIGS. 3 and 4, the accessory mount of the present invention comprises a rigid bracket 55 having first and second ends 60 and 65. First end 60 is adapted for mounting to engine case 22. To this end, first end 60 may be apertured to received a suitable mounting fastener such as a bolt (not shown) engages bracket 55 and case 22. Second end 65 of bracket 55 comprises a clevis having a pair of generally parallel legs 67 apertured to receive a retainer fastener pin 70 therethrough.

The accessory component mount of the present invention also comprises a link 75 apertured at end 80 thereof. Link aperture 80 is aligned with the apertures in clevis 65, the aligned apertures receiving retainer pin 70 therethrough. A fuse bushing 85 surrounds retainer pin 70 and is received within the apertures in end 80 of link 75 and in clevis 65. As best seen in FIG. 3, the end of link 75 within clevis 65 terminates at a spherical bearing 90 which accommodates any axial misalignments between link 75 and bracket 55. As best seen in FIG. 3, spherical bearing 90 is apertured to receive retainer pin 70 and fuse bushing 85 therethrough, the aperture in spherical bearing 90 being aligned with the apertures in link 75 and clevis 65. An elastomer bushing 95 formed from a material such as high temperature resistant, synthetic rubber, surrounds retainer pin 70 between retainer pin 70 and fuse bushing 85 within the interior of spherical bearing 90.

Retainer pin 70 is secured to bracket 65 by a nut 72 threaded on to the end of the pin.

In operation, in the event of a large scale rotor imbalance, due to, for example, separation of a fan blade from the engine's rotor, engine case 22 will experience exaggerated deflections and distortions due to radial movement of the engine's rotor bearings within case 22. These deflections and distortions will cause movement of bracket 55 with the case. Such movement of bracket 55 will cause a shearing of fuse bushing 85 at locations 100 and 105 as bracket 55 moves with respect to link 75 (see FIG. 3). The shearing of fuse bushing 85 absorbs the energy associated with the case distortions and deflections and isolates the movement of bracket 55 from pin 70 and spherical bearing 90, thereby isolating gearbox 40 from such movement. However, since fuse bushing 85 shears, retainer pin 70 continues to provide firm retention of link 75 and thus gearbox 40 on case 22 without the requirement of a separate shearing fastener pin as was employed in prior art arrangements as discussed hereinabove.

While a specific embodiment of the present invention has been shown and described herein, it will be understood that various modifications of this embodiment may suggest themselves to those skilled in the art. For example, while the gas turbine engine accessory mount of the present invention has been described within the context of an accessory gearbox mount, it will be understood and appreciated that the invention hereof may be equally well-suited for mounting other accessories such as oil tanks, heat exchangers, electronic engine controllers and the like to a gas turbine engine case. Also, while specific geometries of the various components employed in the accessory mount of the present invention have been shown and described, it will be appreciated that various modifications to these geometries may be employed without departure from the present invention. Accordingly, it will be understood that these and various other modifications of the preferred embodiment of the present invention as illustrated and described herein may be implemented without departing from the present invention and is intended by the appended claims to cover these and any other such modifications which fall within the true spirit and scope of the invention herein.

Having thus described the invention, what is claimed is:

1. In a gas turbine engine enclosed by a case adapted to support an accessory component on an exterior surface of said case, a mount for said accessory component, said mount comprising:
a bracket adapted for fixed attachment to said exterior surface of said engine case;
a link adapted for connection to said accessory component and said mounting bracket;
said link being connected to said mounting bracket by a fastener received within said link and mounting bracket;
said fastener being disposed within a frangible fuse bushing received within said apertures in said link and mounting bracket.

2. The accessory component mount of claim 1 wherein said mounting bracket includes a clevis, said link being connected to said mounting bracket interiorly of said clevis.

3. The accessory component mount of claim 2 wherein
said clevis includes first and second generally parallel legs;
said fastener being received within aligned apertures in said link and clevis legs.

4. The accessory component mount of claim 3 wherein said fastener comprises an elongate pin.

5. The accessory component mount of claim 2 and further including a bearing connected to said link interiorly of said clevis, said bearing accommodating misalignments of said link with said mounting bracket.

6. The accessory component mount of claim 5 wherein said bearing comprises a spherical bearing.

7. The accessory component mount of claim 6 wherein said spherical bearing includes an aperture therethrough, said fastener and said frangible bushing being received within said spherical bearing aperture.

8. The accessory component mount of claim 1 and further including an elastomeric bushing disposed between said fastener and said frangible bushing, said elastomeric bushing cushioning, said fastener from shock loads applied thereto by said shearing of said frangible fuse bushing.

9. The accessory component mount of claim 8 wherein said elastomer is synthetic rubber.

10. The accessory component mount of claim 1 wherein said accessory is a gearbox.

11. A gas turbine engine including a case having an outer surface and an accessory gearbox mounted on said outer surface of said case by a mount, said mount comprising:
a bracket having opposed ends, said bracket being attached at a first end thereof to said case at said outer surface thereof;
a link having a pair of opposed ends, one of said link ends being attached to said accessory gearbox, the other of said link ends being connected to a second end of said bracket by a fastener, received within aligned apertures in said link and mounting bracket;
said fastener being disposed within a frangible fuse bushing received within said aligned apertures in said link and mounting bracket.

12. The gas turbine engine of claim 11 wherein said mounting bracket at a second end thereof includes a clevis, said fastener being received within aligned apertures in said link and clevis whereby said link is connected to said mounting bracket interiorly of said clevis.

13. The gas turbine engine of claim 12 wherein said fastener comprises an elongate pin.

14. The gas turbine engine of claim 12 and further including a bearing connected to said link and bracket interiorly of said clevis, said bearing accommodating misalignments of said link with said mounting bracket.

15. The gas turbine engine of claim 14 wherein said bearing comprises a spherical bearing.

16. The gas turbine engine of claim 15 wherein said spherical bearing includes an aperture therethrough, said fastener and said frangible fuse bushing being received within said spherical bearing aperture.

17. The gas turbine engine of claim 11 and further including an elastomeric bushing disposed between said fastener and said frangible fuse bushing, said elastomeric bushing cushioning said fastener from shock loads applied thereto by said shearing of said frangible fuse bushing.

18. The gas turbine engine of claim 17 wherein said elastomer is a synthetic rubber.
